(19) United States
(12) Patent Application Publication
(10) Pub. No.: US 2016/0357351 A1
(43) Pub. Date: Dec. 8, 2016

(54) DISPLAY DEVICE

(71) Applicants: BOE TECHNOLOGY GROUP CO., LTD., Beijing (CN); HEFEI XINSHENG OPTOELECTRONICS TECHNOLOGY CO., LTD, Hefei City, Anhui (CN)

(72) Inventors: Zhixiang FANG, Beijing (CN); Ming HU, Beijing (CN); Taofeng XIE, Beijing (CN)

(21) Appl. No.: 14/893,281

(22) PCT Filed: May 15, 2015
(86) PCT No.: PCT/CN2015/079124

§ 371 Date: Nov. 23, 2015

(30) Foreign Application Priority Data
Dec. 24, 2014 (CN) 201410820040.0

(51) Int. Cl. G06F 3/042; G06F 3/041

(52) U.S. Cl. CPC G06F 3/0426; G06F 3/0416

(57) ABSTRACT

A display device is provided. The display device includes a host, a display panel, a touch panel and a projection member, wherein, relative positions of the touch panel and the display panel are changeable, and the display panel is configured to display a display image; the projection member is configured to project a projection image onto the touch panel in a case that the display panel and the touch panel do not coincide; the touch panel is configured to detect a touch operation and generate a touch signal based on the touch operation; and the host is configured to process the display image of the display panel according to the touch signal. The display device is convenient to carry and use, and use diversity of the display device is greatly enhanced.

### TECHNICAL FIELD

An embodiment of the present disclosure relates to a display device.

### BACKGROUND

A tablet computer is a small, flip-needless, no-keyboard, and portable but fully functional Personal Computer (PC). The tablet computer uses a touch screen as a basic input device, and the touch screen of the tablet computer (also called as a digital panel technology) allows a user to operate through a touch pen or digital pen instead of a traditional keyboard or mouse. The user can realize input by built-in handwriting recognition, a soft keyboard on a screen or voice recognition.

The tablet computer is of small size and high integration, so that it is more convenient in use than a common laptop. However, since the tablet computer has no keyboard, its application performance in aspects such as office and game is lower than that of the common laptop.

### SUMMARY

An embodiment of the disclosure provides a display device, comprising a host, a display panel, a touch panel and a projection member, wherein, relative positions of the touch panel and the display panel are changeable, and the display panel is configured to display a display image; the projection member is configured to project a projection image onto the touch panel in a case that the display panel and the touch panel do not coincide; the touch panel is configured to detect a touch operation, and generate a touch signal based on the touch operation; and the host is configured to process the display image of the display panel according to the touch signal.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic diagram of a display device provided by an embodiment of the disclosure in a mode;

FIG. 2 is a schematic diagram of the display device provided by the embodiment of the disclosure in another mode;

FIG. 3 is a schematic diagram of the display device as shown in FIG. 1 with a projection virtual keyboard in the mode as shown in FIG. 1;

FIG. 4 is a schematic diagram of a host provided by an embodiment of the disclosure;

FIG. 5 is a schematic diagram of another host provided by an embodiment of the disclosure.

### DETAILED DESCRIPTION

The technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

An embodiment of the disclosure provides a display device, capable of solving the problem that the existing display device has no keyboard and thus has good portability but the use performance is lowered.

The display device provided by the embodiment of the disclosure will be described in combination with FIG. 1-FIG. 3. A display device 100 comprises a host 1, a display panel 2, and a touch panel 3 pivotally connected with the display panel 2. The display panel 2 and the touch panel 3 each have one edge rotationally connected with each other, and an angle α between the display panel 2 and the touch panel 3, for example, may range from 0° to 180°. The display device 100, for example, further comprises a projection member, such as a projecting camera 21, positioned on the display panel 2. The touch panel 3 is used for detecting a touch operation and generating a touch signal. The host 1 is used for processing image information of the display panel according to the touch signal.

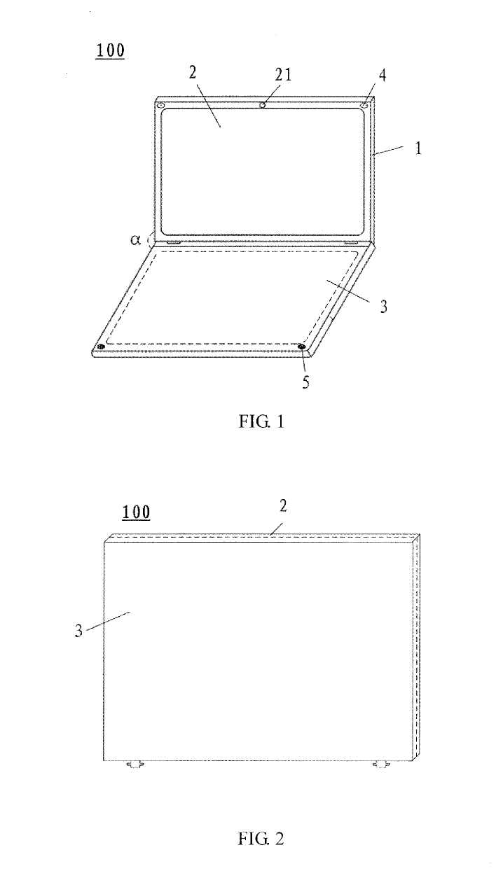

In a first mode, as shown in FIG. 2, the display panel 2 and the touch panel 3 coincide with each other, and the angle α therebetween is 0. In this condition, a user can view image information displayed on the display panel 2 via the touch panel 3, and carry out a touch operation on the touch panel 3 according to the image information displayed on the display panel 2 to generate a touch signal so as to control the image information displayed on the display panel 2.

In a second mode, as shown in FIG. 1, the display panel 2 and the touch panel 3 are opened to form an angle α greater than 0. In this condition, a user can directly view the image information displayed on the display panel 2, and the projecting camera 21 on the display panel 2 is turned on to project a projection image onto the touch panel 3, so that the user can conveniently carry out a touch operation on the touch panel 3 according to the projection image so as to generate a touch signal for controlling the image information displayed on the display panel 2.

It should be explained that in the embodiment of the disclosure, the touch panel and the display panel are connected and can be opened and closed in a manner like a hard connection manner of a display screen and a host of an existing laptop, which will not be illustrated in detail herein. In the embodiment of the disclosure, transmittance of the touch panel is, for example, greater than or equal to 75%, so that in the first mode, the image of the display panel can still be clearly presented through the touch panel. Of course, the transmittance of the touch panel can also be less than 75%, and in such case, definition can be improved by increase display brightness of the display panel. The embodiment of the disclosure only takes the case that the transmittance of the touch panel is greater than or equal to 75% as an example for detailed description. The display device comprises a host which can include modules with image processing function, such as a CPU, a graphics card, a drive module. The host is used for processing the image information on the display panel according to a touch signal. In the embodiment of the disclosure, the host can process the touch information generated according to the touch operation in both the first and second modes.

In the first mode, as shown in FIG. 2, the display panel 2 and the touch panel 3 are closed to coincide with each other, for example, the touch panel 3 is positioned on the display panel 2. A user can control the image information displayed on the display panel 2 by touching the touch panel 3.

In the second mode, as shown in FIG. 1, the display panel 2 and the touch panel 3 are opened by a certain angle (for example, the angle a between the display panel 2 and the touch panel 3 is equal to 90°, or any other angles), the projecting camera 21 of the display panel 2 is turned on to project a projection image to display on the touch panel 3, and the display panel 2 can display a display image.

It should be explained that the projection image can include: a virtual keyboard or a display image.

The display image may be, for example, a webpage image. For example, in a case that a first webpage and a second webpage need to be opened simultaneously, the display panel 2 can display a first webpage image, while a second webpage image as the projection image can be projected onto the touch panel 3 by the projecting camera 21; In this case, a user can carry out a touch operation on the projection image on the touch panel 3.

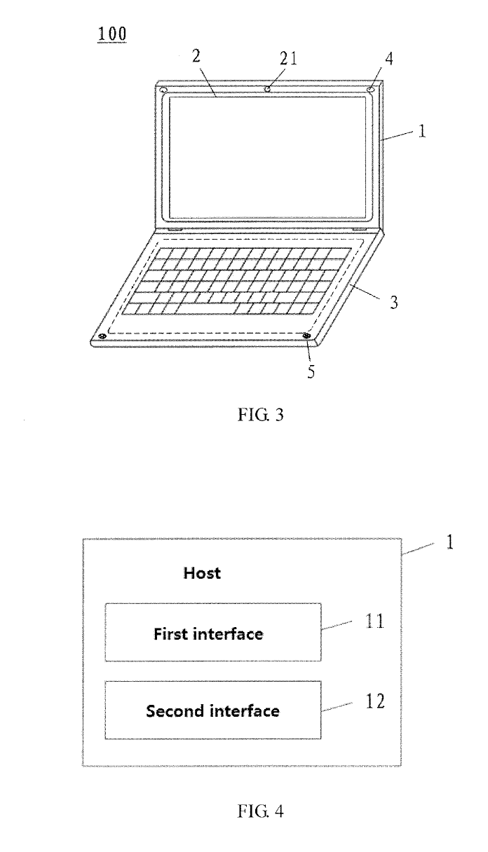

Alternatively, as shown in FIG. 3, the display panel 2 can display a Word document, and the projection image projected onto the touch panel 3 by the projecting camera 21 is, for example, a virtual keyboard; In this case, a user can carry out a touch operation on the virtual keyboard to accomplish editing of the Word document on the display panel 2. It should be explained that the virtual keyboard may be a preset projection image. That is, the projecting camera of the display panel can be controlled by the host to be turned on to project a particular image, such as a virtual keyboard.

In view of the above, the display device provided by the embodiment of the disclosure can realize different display functions in different modes, thus convenient to carry and use. The use diversity of the display device is greatly enhanced.

Alternatively, the host 1 can also be configured for controlling the projecting camera 21 to change a projection angle or zoom the projection image, so that a projection area on the touch panel matches with an area of the touch panel.

Considering that a projection image of the projecting camera may be affected by the angle between the display panel and the touch panel of the display device, for example, the projection image may exceeds the area of the touch panel, it is necessary to modify the projection image of the projecting camera. In this case, the host is further configured for controlling the projecting camera to change the projection angle or zoom the projection image for projection, so that the projection area on the touch panel matches with the area of the touch panel. For example, when the angle between the display panel and the touch panel is changed, the host controls the projecting camera to change the projection angle or zoom the projection image for projection, so as to match the area of the touch panel. The angle between the display panel and the touch panel may be detected in a manner of detecting an angle of rotary shafts between the display panel and the touch panel, or in a manner of arranging a sensor capable of detecting the angle therebetween on the display panel and/or the touch panel. In the embodiment of the disclosure, the projecting camera can always enable the projection image to be accurately projected in a region of the touch panel.

In the embodiment of the disclosure, as shown in FIG. 1 and FIG. 3, the display panel 2 is arranged on the host 1. Alternatively, in another embodiment, the display panel 2 and the host 1 can be physically separated, and communicated with each other via wifi, Bluetooth or the like. In the embodiment of the disclosure, as shown in FIG. 1 and FIG. 3, the display panel 2 and the touch panel 3 are pivotally connected. In another embodiment, the display panel 2 and the touch panel 3 can be physically separated. In the case that the display panel 2 the touch panel 3 and the host 1 are separated from one another, the display panel 2 and the touch panel 3 can communicate with the host 1 via wifi, Bluetooth or the like, respectively. The embodiment of the disclosure only takes what is shown in FIG. 1 as an example for detailed description and is not intended to limit a positional relationship among the display panel, the touch panel and the host.

Alternatively, as shown in FIG. 4, the host 1 includes a first interface 11 and a second interface 12; the host 1 drives image information of the display panel via the first interface 11; the host 1 drives the projecting camera to be turned on via the second interface 12 to generate a projection image.

For example, the host 1 includes a dual graphics card, and the case that the host includes the first interface and the second interface may be that the dual graphics card includes the first interface and the second interface. Further, the first interface may be a Video Graphics Array (VGA) interface, and the second interface may be a Digital Visual Interface (DVI). It should be explained that the driving manner of the host to the display image and projection image of the display panel is not limited to the above manners, and the embodiments of the disclosure only take the above mentioned as an example for description.

Alternatively, the display device further comprises a switch; in the first mode, the switch is closed to turn off the second interface; in the second mode, the switch is opened to turn on the second interface. That is, the switch controls the on or off state of the second mode, and then the host determines whether to turn on the projecting camera.

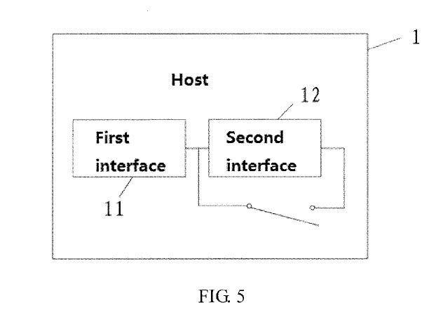

In an example, as shown in FIG. 5, the first interface 11 and the second interface 12 are connected in series, and the second interface 12 and the switch are connected in parallel. In the first mode, the switch is closed to cause the second interface to short-circuit, and the display panel displays image by the first interface; in the second mode, the switch is opened to turn on the projecting camera to generate a projection image and project the projection image onto the touch panel.

In an example, the switch can be a limit switch, wherein, the switch includes a switch body and a trigger structure; in a case that the switch body and the trigger structure are in contact, the switch is closed; in a case that the switch body and the trigger structure are disconnected, the switch is opened. For example, the limit switch can be opened and closed in other manners, and the embodiment of the disclosure only takes the above mentioned as an example for detailed description.

Alternatively, in a case that the angle between the display panel and the touch panel is smaller than a preset angle, the switch body and the trigger structure come into contact; in a case that the angle a between the display panel and the touch panel is larger than or equal to the preset angle, the switch body and the trigger structure are disconnected. That is, the opening and closing of the switch are determined by the angle between the display panel and the touch panel. The preset angle can be any angle set as required, for example, 30°, 60°, 90° or the like.

Or, as shown in FIG. 1, the switch body 4 is arranged on the display panel 2, and the trigger structure 5 is arranged on the touch panel 3. In this case, if the touch panel 3 and the display panel 2 are opened, the trigger structure and the switch body are disconnected and the switch is opened; if the touch panel 3 and the display panel 2 come into contact, the trigger structure and the switch body are in contact and the switch is closed.

Or, alternatively, the switch body and the trigger structure can be both arranged on the display panel. Or, the switch body and the trigger structure can be both arranged on the touch panel.

Alternatively, the touch panel is a capacitive touch panel, a resistive touch panel or an inductive touch panel. The embodiment of the disclosure does not limit the touch manner of the touch panel.

According to the above description, the embodiment according to the disclosure at least provides structures of:

(1) A display device, comprising a host, a display panel, a touch panel and a projection member, wherein, relative positions of the touch panel and the display panel are changeable, and the display panel is configured to display a display image; the projection member is configured to project a projection image onto the touch panel in a case that the display panel and the touch panel do not coincide; the touch panel is configured to detect a touch operation and generating a touch signal based on the touch operation; and the host is configured to process the display image of the display panel according to the touch signal.

(2) The display device according to (1), wherein, the touch panel and the display panel are configured to be pivotally connected with each other.

(3) The display device according to (1) or (2), wherein, the projection member is a projecting camera, and is arranged on the display panel.

(4) The display device according to any one of (1) to (3), wherein, in a case that the display panel and the touch panel coincide, the touch panel is used for detecting a touch operation related to the display image to generate the touch signal;

in the case that the display panel and the touch panel do not coincide, the touch panel is used for detecting a touch operation related to the projection image to generate the touch signal.

(5) The display device according to any one of (1) to (4), wherein, the host includes a first interface and a second interface;

the display panel is driven by the host via the first interface to display the display image;

the projecting camera is driven by the host via the second interface to be turned on and generate a projection image.

(6) The display device according to (5), wherein, the host further includes a switch which is connected with a first drive module in series and connected with a second drive module in parallel; in the case that the display panel and the touch panel coincide, the switch is closed to turn off the second interface; in the case that the display panel and the touch panel do not coincide, the switch is opened to turn on the second interface.

(7) The display device according to (6), wherein, the switch is a limit switch; the switch includes a switch body and a trigger structure; where the switch body and the trigger structure come into contact, the switch is closed, and where the switch body and the trigger structure are disconnected, the switch is opened.

(8) The display device according to (7), wherein,

in a case that the angle between the display panel and the touch panel is smaller than a preset angle, the switch body and the trigger structure are in contact;

in a case that the angle between the display panel and the touch panel is larger than or equal to the preset angle, the switch body and the trigger structure are disconnected.

(9) The display device according to (7) or (8), wherein, the switch body is arranged on one of the display panel and the touch panel, and the trigger structure is arranged on the other of the display panel and the touch panel; or,

the switch body and the trigger structure are both arranged on the display panel, or the switch body and the trigger structure are both arranged on the touch panel.

(10) The display device according to any one of (1) to (9), wherein, the projection image includes: a virtual keyboard or a display image.

(11) The display device according to any one of (1) to (10), wherein, the host is further configured for controlling the projection member to change a projection angle or zoom the projection image, so that a projection area on the touch panel matches with an area of the touch panel.

(12) The display device according to any one of (1) to (11), wherein, the touch panel is a capacitive touch panel, a resistive touch panel or an inductive touch panel.

(13) The display device according to any one of (1) to (12), wherein, the display panel is arranged on the host.

Although the embodiment of the disclosure has been described above in great detail with general descriptions and specific embodiments, on the basis of the embodiment of the disclosure, various changes and improvements may be made, which is apparent to those skilled in the art. Therefore, all such changes and improvements without departing from the spirit of the disclosure are within the scope of the claims of the disclosure.

The application claims priority of Chinese Patent Application No. 201410820040.0 filed on Dec. 24, 2014, the disclosure of which is incorporated herein by reference in its entirety as part of the present application.

1. A display device, comprising a host, a display panel, a touch panel and a projection member, wherein, relative positions of the touch panel and the display panel are changeable, and the display panel is configured to display a display image; the projection member is configured to project a projection image onto the touch panel in a case that the display panel and the touch panel do not coincide; the touch panel is configured to detect a touch operation and generate a touch signal based on the touch operation; and the host is configured to process the display image of the display panel according to the touch signal.

2. The display device according to claim 1, wherein, the touch panel and the display panel are configured to be pivotally connected with each other.

3. The display device according to claim 1, wherein, the projection member is a projecting camera, and is arranged on the display panel.

4. The display device according to claim 1, wherein, in a case that the display panel and the touch panel coincide, the touch panel is used for detecting a touch operation related to the display image to generate the touch signal;
in the case that the display panel and the touch panel do not coincide, the touch panel is used for detecting a touch operation related to the projection image to generate the touch signal.

5. The display device according to claim 1, wherein, the host includes a first interface and a second interface;
the display panel is driven by the host via the first interface to display the display image;
the projecting camera is driven by the host via the second interface to be turned on and generate a projection image.

6. The display device according to claim 5, wherein, the host further includes a switch which is connected with a first drive module in series and connected with a second drive module in parallel; in the case that the display panel and the touch panel coincide, the switch is closed to turn off the second interface; in the case that the display panel and the touch panel do not coincide, the switch is opened to turn on the second interface.

7. The display device according to claim 6, wherein, the switch is a limit switch; the switch includes a switch body and a trigger structure; where the switch body and the trigger structure come into contact, the switch is closed, and where the switch body and the trigger structure are disconnected, the switch is opened.

8. The display device according to claim 7, wherein,
in a case that an angle between the display panel and the touch panel is smaller than a preset angle, the switch body and the trigger structure are in contact;
in a case that the angle between the display panel and the touch panel is larger than or equal to the preset angle, the switch body and the trigger structure are disconnected.

9. The display device according to claim 7, wherein, the switch body is arranged on one of the display panel and the touch panel, and the trigger structure is arranged on the other one of the display panel and the touch panel; or,
the switch body and the trigger structure are both arranged on the display panel, or the switch body and the trigger structure are both arranged on the touch panel.

10. The display device according to claim 1, wherein, the projection image includes: a virtual keyboard or a display image.

11. The display device according to claim 1, wherein, the host is further configured for controlling the projection member to change a projection angle or zoom the projection image, so that a projection area on the touch panel matches with an area of the touch panel.

12. The display device according to claim 1, wherein, the touch panel is a capacitive touch panel, a resistive touch panel or an inductive touch panel.

13. The display device according to claim 1, wherein, the display panel is arranged on the host.
